(19) United States
(12) Patent Application Publication
(10) Pub. No.: US 2019/0027029 A1
(43) Pub. Date: Jan. 24, 2019

(54) CONGESTION PREDICTION DEVICE AND CONGESTION PREDICTION METHOD

(71) Applicant: Mitsubishi Electric Corporation, Tokyo (JP)

(72) Inventor: Junya MIYAGI, Tokyo (JP)

(73) Assignee: Mitsubishi Electric Corporation, Tokyo (JP)

(21) Appl. No.: 16/069,680

(22) PCT Filed: Mar. 3, 2016
(86) PCT No.: PCT/JP2016/056581

§ 371 Date: Jul. 12, 2018

(51) Int. Cl. G08G 1/01; G08G 1/065; G06N 5/04

(52) U.S. Cl. CPC G08G 1/0133; G06N 5/046; G08G 1/065; G08G 1/0129

(57) ABSTRACT

A prediction data generating unit predicts the number of persons who will pass through a measurement point in a future time, by using measurement data outputted by a sensor for measuring the number of persons who have passed through the measurement point, thereby generating prediction data. A congestion prediction processing unit predicts a congestion state of the measurement point in a future time by using the prediction data generated by the prediction data generating unit, thereby generating and outputting congestion prediction data.

### TECHNICAL FIELD

The present invention relates to a congestion prediction device that performs congestion prediction when an event is held, or in a similar situation, and a method for use in the device.

### BACKGROUND ART

For example, in an event security monitoring method described in Patent Literature 1, first, a turnout at an entry and exit point of a transportation facility or the like directly related to a turnout in a security target area, such as an event site or a path, is predicted on the basis a past record, past data, or the like, and entry and exit data about turnout is prepared in advance. When security operations are performed, cameras are installed at neighboring points greatly related to the turnout in the security target area, and images are shot by the cameras. An event security monitoring device measures a flow of people at each of the neighboring points by performing image processing on a corresponding shot image, and predicts congestion at each of the neighboring points and congestion in the security target area by using a measured value of the corresponding flow of people, and using the entry and exit data about turnout which is prepared in advance.

### CITATION LIST

### Patent Literature

Patent Literature 1: Japanese Unexamined Patent Application Publication No. 2004-178358

### SUMMARY OF INVENTION

### Technical Problem

A problem with conventional congestion prediction devices is that although it is necessary to predict a turnout and prepare entry and exit data in advance, it is difficult to prepare entry and exit data for a first-time event or a place where an event is held for the first time.

The present invention is made in order to solve the above-mentioned problem, and it is therefore an object of the present invention to eliminate the necessity to prepare data used for congestion prediction in advance, and make it possible to perform congestion prediction in a first-time event or at a place where an event is held for the first time.

### Solution to Problem

A congestion prediction device according to the present invention, includes: a prediction data generating unit for predicting the number of persons who will pass through a measurement point in a future time, by using measurement data outputted by a sensor for measuring the number of persons who have passed through the measurement point, thereby generating prediction data; and at least one congestion prediction processing unit for predicting a congestion state of the measurement point in a future time by using the prediction data generated by the prediction data generating unit, thereby generating and outputting congestion prediction data.

### Advantageous Effects of Invention

According to the present invention, because the number of persons who will pass in a future time is predicted by using measurement data about the number of persons who have passed through the measurement point, and a congestion state of the measurement point in a future time is predicted by using the prediction data, it is not necessary to prepare data used for the congestion prediction in advance, and it is possible to perform the congestion prediction in a first-time event or at a place where an event is held for the first time.

### BRIEF DESCRIPTION OF DRAWINGS

FIG. 1 is a diagram of a functional configuration of a congestion prediction device according to Embodiment 1 of the present invention;

FIG. 2 is a diagram of a hardware configuration of the congestion prediction device according to Embodiment 1;

FIG. 3 is a sequence diagram showing processing performed by the congestion prediction device according to Embodiment 1;

FIG. 4 is a flow chart showing processing performed by a measurement data storage unit of the congestion prediction device according to Embodiment 1;

FIG. 5 is a flow chart showing processing performed by a prediction data generating unit of the congestion prediction device according to Embodiment 1;

FIG. 6 is a flow chart showing processing performed by a prediction data storage unit of the congestion prediction device according to Embodiment 1;

FIG. 7 is a flow chart showing processing performed by a congestion prediction processing unit of the congestion prediction device according to Embodiment 1;

FIG. 8 is a diagram of a functional configuration of a congestion prediction device according to Embodiment 2 of the present invention;

FIG. 9 is a sequence diagram showing processing performed by the congestion prediction device according to Embodiment 2;

FIG. 10 is a flow chart showing processing performed by a measurement data storage unit of the congestion prediction device according to Embodiment 2;

FIG. 11 is a flow chart showing processing performed by a prediction data generating unit of the congestion prediction device according to Embodiment 2;

FIG. 12 is a flow chart showing processing performed by a prediction data storage unit of the congestion prediction device according to Embodiment 2;

FIG. 13 is a flow chart showing processing performed by a congestion prediction processing unit of the congestion prediction device according to Embodiment 2; and

FIG. 14 is a flow chart showing processing performed by a difference calculating unit of the congestion prediction device according to Embodiment 2.

### DESCRIPTION OF EMBODIMENTS

Hereafter, in order to explain this invention in greater detail, embodiments of the present invention will be described with reference to the accompanying drawings.

### Embodiment 1

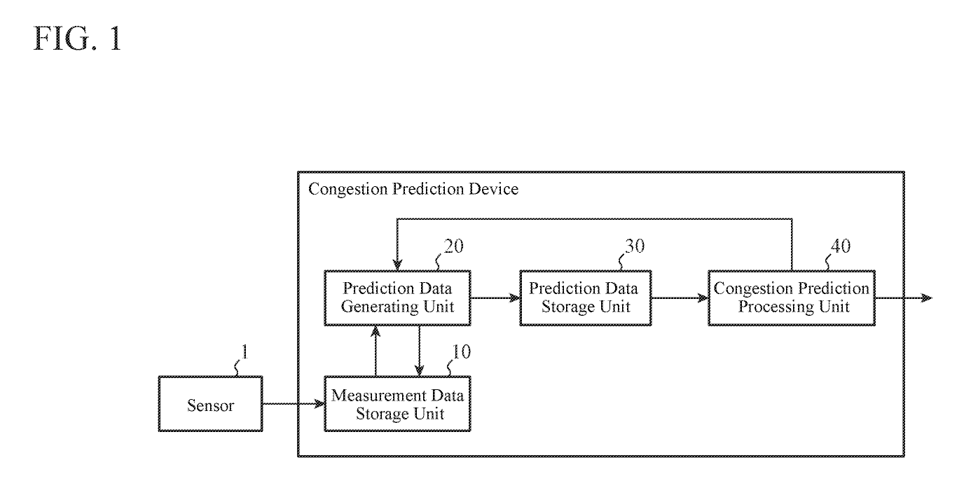

FIG. 1 is a diagram of a functional configuration of a congestion prediction device according to Embodiment 1 of the present invention. This congestion prediction device predicts, when an event is held, a congestion state of a path extending from a location where people appear, for example, a public transportation facility such as a station or a bus stop, or a parking lot, to an event site. A sensor 1 is installed on the path extending from the location where people appear to the event site, and the sensor 1 and the congestion prediction device are connected.

A position where the sensor 1 is installed on the path extending from the location where people appear to the event site is referred to as a measurement point. The sensor 1 measures the number of persons who have passed through the measurement point in an incoming direction or in an outgoing direction, thereby generating time series data, and outputs the time series data to the congestion prediction device. This sensor 1 includes, for example, a camera, and performs image processing on an image shot by the camera, thereby measuring the number of persons who have passed. Hereafter, the time series data generated by the sensor 1 is referred to as measurement data.

The congestion prediction device includes a measurement data storage unit 10, a prediction data generating unit 20, a prediction data storage unit 30, and a congestion prediction processing unit 40. The measurement data storage unit 10 stores the measurement data outputted by the sensor 1. The prediction data generating unit 20 predicts the number of persons who will pass through the measurement point in a future time by using measurement data stored by the measurement data storage unit 10, thereby generating time series data, and outputs the time series data, as prediction data, to the prediction data storage unit 30. The prediction data storage unit 30 stores the prediction data outputted by the prediction data generating unit 20, and outputs prediction data stored therein, as selected prediction data, to the congestion prediction processing unit 40. The congestion prediction processing unit 40 predicts the congestion state of the measurement point in a future time by using the selected prediction data outputted by the prediction data storage unit 30, thereby generating congestion prediction data, and outputs the congestion prediction data to the outside.

The sensor 1 can measure either only one of the number of persons who have passed through the measurement point in the incoming direction, and the number of persons who have passed through the measurement point in the outgoing direction, or both of the numbers. For example, when the measurement data is a result of measuring the number of persons who have passed through the measurement point in the incoming direction, the prediction data generating unit 20 generates prediction data which is a result of predicting the number of persons who will pass in only the incoming direction, and the congestion prediction processing unit 40 generates congestion prediction data which is a result of predicting a congestion state of only the incoming direction. In this way, the descriptions of the prediction data and the congestion prediction data also change depending on whether the measurement target is the incoming direction, the outgoing direction, or both of the directions.

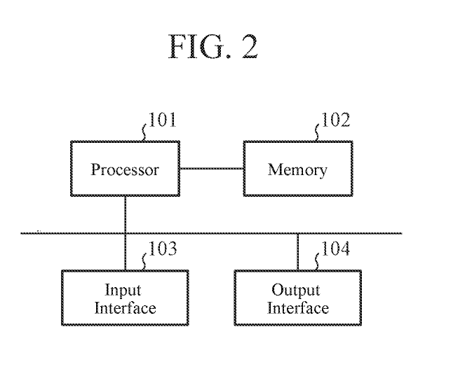

FIG. 2 is a diagram of a hardware configuration of the congestion prediction device. The congestion prediction device includes a processor 101, a memory 102, an input interface 103, and an output interface 104. The input interface 103 inputs the measurement data from the sensor 1 to the measurement data storage unit 10. The output interface 104 outputs the congestion prediction data from the congestion prediction processing unit 40 to an external device such as a display.

The functions of the prediction data generating unit 20 and the congestion prediction processing unit 40 in the congestion prediction device are implemented by a processing circuit. More specifically, the congestion prediction device includes the processing circuit for generating prediction data by using measurement data, and for generating congestion prediction data by using prediction data. The processing circuit is the processor 101 that executes a program stored in the memory 102. The processor 101 can be a Central Processing Unit (CPU), a processing device, an arithmetic device, a microprocessor, a microcomputer, a Digital Signal Processor (DSP), or the like.

The functions of the prediction data generating unit 20 and the congestion prediction processing unit 40 are implemented by software, firmware, or a combination of software and firmware. Software or firmware is described as a program and the program is stored in the memory 102. The processor 101 implements the function of each of the units by reading and executing a program stored in the memory 102. More specifically, the congestion prediction device includes the memory 102 for storing programs by which the step of generating prediction data by using measurement data and the step of generating congestion prediction data by using prediction data are executed as a result of execution of the programs by the processor 101. Further, it can be said that these programs cause a computer to execute procedures or methods which the prediction data generating unit 20 and the congestion prediction processing unit 40 use.

Here, the memory 102 is, for example, a non-volatile or volatile semiconductor memory such as a Random Access Memory (RAM), a Read Only Memory (ROM), an Erasable Programmable ROM (EPROM), an Electrically EPROM (EEPROM), a flash memory, or a Solid State Drive (SSD), a magnetic disc such as a hard disc or a flexible disc, or an optical disc such as a Compact Disc (CD) or a Digital Versatile Disc (DVD).

The measurement data storage unit 10 and the prediction data storage unit 30 in the congestion prediction device are implemented by the memory 102.

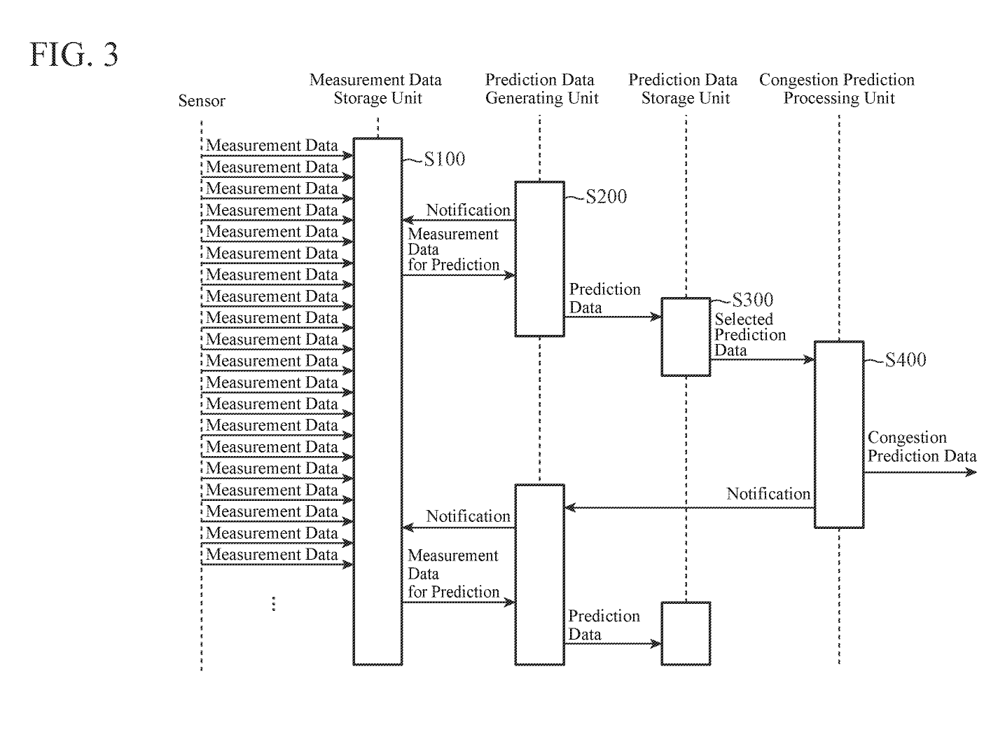

Next, the operation of the congestion prediction device according to Embodiment 1 will be explained using FIGS. 3 to 7.

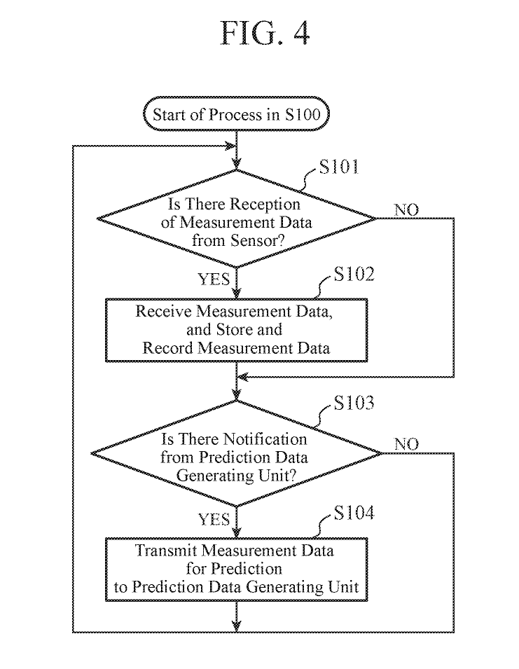

FIG. 3 is a sequence diagram showing processing performed by the congestion prediction device according to Embodiment 1. FIG. 4 is a flow chart showing processing performed by the measurement data storage unit 10 of the congestion prediction device according to Embodiment 1. Processes in steps S101 to S104 of this FIG. 4 are performed in step S100 of FIG. 3.

In step S101 of FIG. 4, the measurement data storage unit 10 checks whether or not there is reception of measurement data from the sensor 1 via the input interface 103. When there is reception of measurement data (“YES” in step S101), the measurement data storage unit 10 advances to step S102, whereas when there is no reception (“NO” in step S101), the measurement data storage unit advances to step S103.

In step S102, the measurement data storage unit 10 receives the measurement data from the sensor 1 via the input interface 103, and stores the measurement data.

Instep S103, the measurement data storage unit 10 checks whether or not there is a notification from the prediction data generating unit 20. When there is a notification from the prediction data generating unit 20 (“YES” in step S103), the measurement data storage unit 10 advances to step S104, whereas when there is no notification (“NO” in step S103), the measurement data storage unit returns to step S101.

In step S104, the measurement data storage unit 10 selects, from the measurement data stored therein, measurement data within a predetermined range, and transmits the measurement data selected thereby, as measurement data for prediction, to the prediction data generating unit 20. The predetermined range can be set to the measurement data storage unit 10 in advance, or can be set from outside the congestion prediction device as needed. For example, when receiving a notification from the prediction data generating unit 20, the measurement data storage unit 10 transmits the time series data which has been acquired until the time of receiving the notification since the time which precedes the time of receiving by the predetermined range, as measurement data for prediction, to the prediction data generating unit 20.

After step S104, the measurement data storage unit 10 returns to step S101.

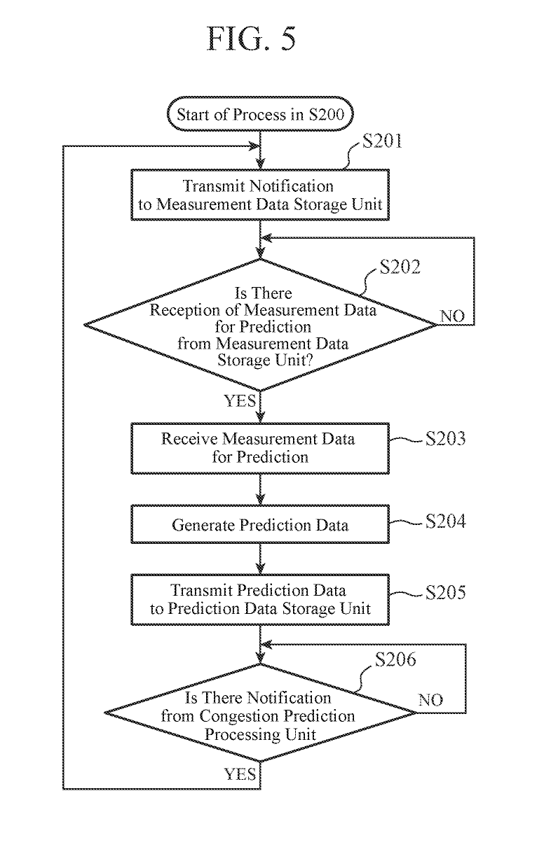

FIG. 5 is a flow chart showing processing performed by the prediction data generating unit 20 of the congestion prediction device according to Embodiment 1. Processes in steps 5201 to 5206 of this FIG. 5 are performed in step S200 of FIG. 3.

In step S201 of FIG. 5, the prediction data generating unit 20 transmits a notification to the measurement data storage unit 10. This notification causes the measurement data storage unit 10 to transmit measurement data for prediction to the prediction data generating unit 20.

In step S202, the prediction data generating unit 20 checks whether or not there is reception of measurement data for prediction from the measurement data storage unit 10. When there is reception of measurement data for prediction (“YES” in step S202), the prediction data generating unit 20 advances to step S203, whereas when there is no reception (“NO” in step S202), the prediction data generating unit repeats this step S202.

In step S203, the prediction data generating unit 20 receives the measurement data for prediction from the measurement data storage unit 10, and stores the measurement data for prediction.

In step S204, the prediction data generating unit 20 predicts the number of persons who will pass through the measurement point during a future time period corresponding to a prediction data generation range, by using a linear approximation or the like, thereby generating prediction data. The prediction data generation range is a parameter for determining until when in the future from now the number of persons who will pass is to be predicted. The prediction data generation range can be set to the prediction data generating unit 20 in advance, or can be set from outside the congestion prediction device as needed.

In step S205, the prediction data generating unit 20 transmits the prediction data generated in step S204 to the prediction data storage unit 30.

In step S206, the prediction data generating unit 20 checks whether or not there is a notification from the congestion prediction processing unit 40. When there is a notification from the congestion prediction processing unit 40 (“YES” in step S206), the prediction data generating unit 20 returns to step S201, whereas when there is no notification (“NO” in step S206), the prediction data generating unit repeats this step S206.

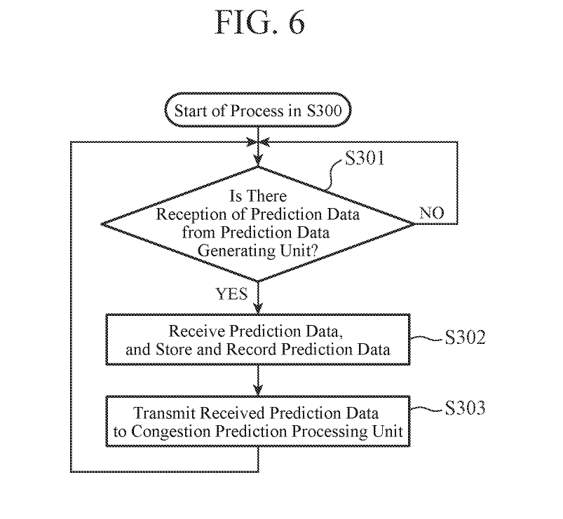

FIG. 6 is a flow chart showing processing performed by the prediction data storage unit 30 of the congestion prediction device according to Embodiment 1. Processes in steps S301 to S303 of this FIG. 6 are performed in step S300 of FIG. 3.

In step S301 of FIG. 6, the prediction data storage unit 30 checks whether or not there is reception of prediction data from the prediction data generating unit 20. When there is reception of prediction data (“YES” in step S301), the prediction data storage unit 30 advances to step S302, whereas when there is no reception (“NO” in step S301), the prediction data storage unit repeats this step S301.

In step S302, the prediction data storage unit 30 receives the prediction data from the prediction data generating unit 20, and stores the prediction data.

In step S303, the prediction data storage unit 30 selects the prediction data stored in step S302, and transmits the prediction data, as selected prediction data, to the congestion prediction processing unit 40.

After step S303, the prediction data storage unit 30 returns to step S301.

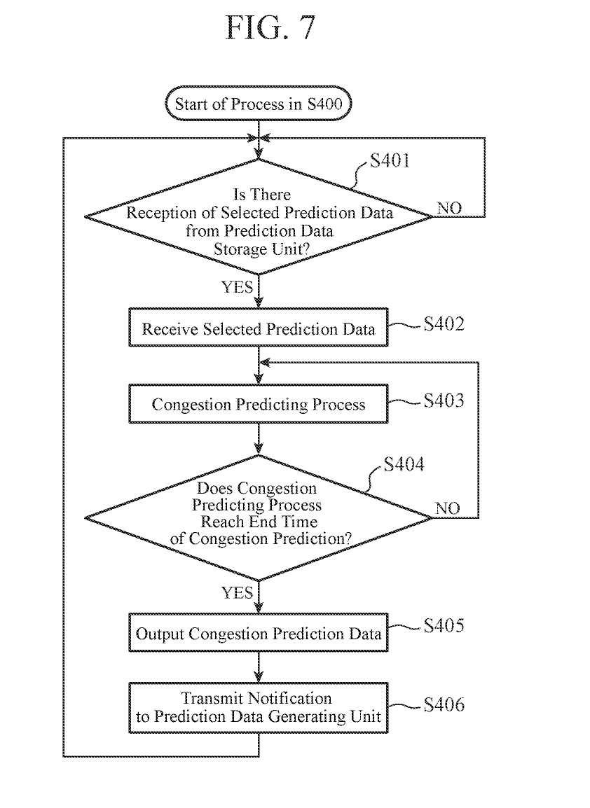

FIG. 7 is a flow chart showing processing performed by the congestion prediction processing unit 40 of the congestion prediction device according to Embodiment 1. Processes in steps S401 to S406 of this FIG. 7 are performed in step S400 of FIG. 3.

In step S401 of FIG. 7, the congestion prediction processing unit 40 checks whether or not there is reception of selected prediction data from the prediction data storage unit 30. When there is reception of selected prediction data (“YES” in step S401), the congestion prediction processing unit 40 advances to step S402, whereas when there is no reception (“NO” in step S401), the congestion prediction processing unit returns to step S401.

In step S402, the congestion prediction processing unit 40 receives the selected prediction data from the prediction data storage unit 30.

In step S403, the congestion prediction processing unit 40 performs a congestion predicting process on the basis of a method such as a multi-agent simulation, by using the selected prediction data received, in step S402, from the prediction data storage unit 30, thereby generating congestion prediction data of the measurement point. The congestion prediction data is, for example, time series data about the flow and density of people existing around the measurement point.

In step S404, the congestion prediction processing unit 40 checks whether the congestion predicting process has reached an end time of congestion prediction. The end time of congestion prediction is a parameter for determining until when in the future from a start time of congestion prediction the congestion prediction is to be performed. The following inequality: an end time of the prediction data generation range the end time of congestion prediction is established. The end time of congestion prediction can be set to the congestion prediction processing unit 40 in advance, or can be set from outside the congestion prediction device as needed. When the congestion predicting process has reached the end time of congestion prediction (“YES” in step S404), the congestion prediction processing unit 40 advances to step S405, whereas when the congestion predicting process has not reached the end time of congestion prediction (“NO” in step S404), the congestion prediction processing unit returns to step S403 and continues the congestion predicting process.

In step S405, the congestion prediction processing unit 40 outputs the congestion prediction data via the output interface 104.

In step S406, the congestion prediction processing unit 40 transmits a notification to the prediction data generating unit 20. This notification instructs the prediction data generating unit 20 to generate new prediction data, and the prediction data generating unit 20 which has received this notification makes a request of the measurement data storage unit 10 for measurement data for prediction.

After step S406, the congestion prediction processing unit 40 returns to step S401.

As mentioned above, the congestion prediction device according to Embodiment 1 is configured so as to include the prediction data generating unit 20 that predicts the number of persons who will pass through a measurement point in a future time, by using measurement data outputted by the sensor 1 that measures the number of persons who have passed through the measurement point, thereby generating prediction data, and the congestion prediction processing unit 40 that predicts a congestion state of the measurement point in a future time by using the prediction data generated by the prediction data generating unit 20, thereby outputting congestion prediction data. As a result, because it is possible to generate prediction data used for the congestion prediction in a real time, it is not necessary to prepare prediction data in advance, and the congestion prediction in a first-time event or at a place where an event is held for the first time can be performed.

### Embodiment 2

In Embodiment 2, measurement data which a sensor 1 newly outputs while at least one congestion prediction processing unit 40 performs a process of predicting a congestion state is reflected in congestion prediction data, and the congestion prediction data are outputted.

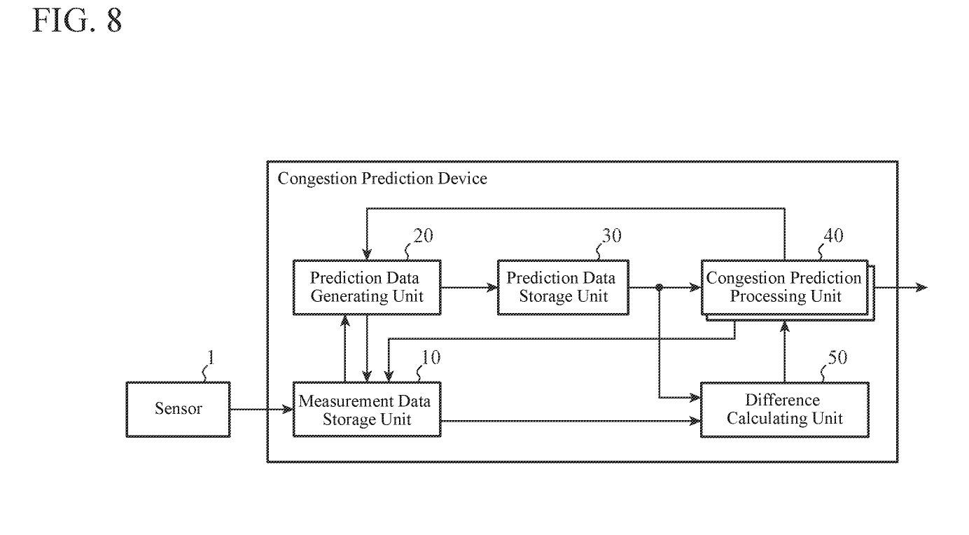

FIG. 8 is a diagram of a functional configuration of a congestion prediction device according to Embodiment 2 of the present invention. In FIG. 8, the same components as those shown in FIG. 1 or like components are denoted by the same reference numerals.

The congestion prediction device according to Embodiment 2 has a configuration in which a difference calculating unit 50 is added to the congestion prediction device according to Embodiment 1 shown in FIG. 1. The function of this difference calculating unit 50 is implemented by a process of reading and executing a program stored in a memory 102, the process being performed by a processor 101 shown in FIG. 2.

The difference calculating unit 50 selects, from among plural prediction data generated by a prediction data generating unit 20, prediction data having the smallest difference between the prediction data and measurement data which the sensor 1 newly outputs while the at least one congestion prediction processing unit 40 performs the congestion predicting process, and notifies the at least one congestion prediction processing unit 40 of the selected prediction data. The prediction data having the smallest difference between the prediction data and the measurement data is optimal prediction data which makes it possible to predict the congestion state with a high degree of accuracy.

Further, the congestion prediction device according to Embodiment 2 includes plural congestion prediction processing units 40. The plural congestion prediction processing units 40 generate respective plural congestion prediction data by using the respective plural prediction data generated by the prediction data generating unit 20. Among the plural congestion prediction processing units 40, the congestion prediction processing unit 40 which has performed the congestion predicting process by using the prediction data selected by the difference calculating unit 50 outputs the congestion prediction data generated thereby to the outside, and the remaining congestion prediction processing units 40 discard their respective congestion prediction data.

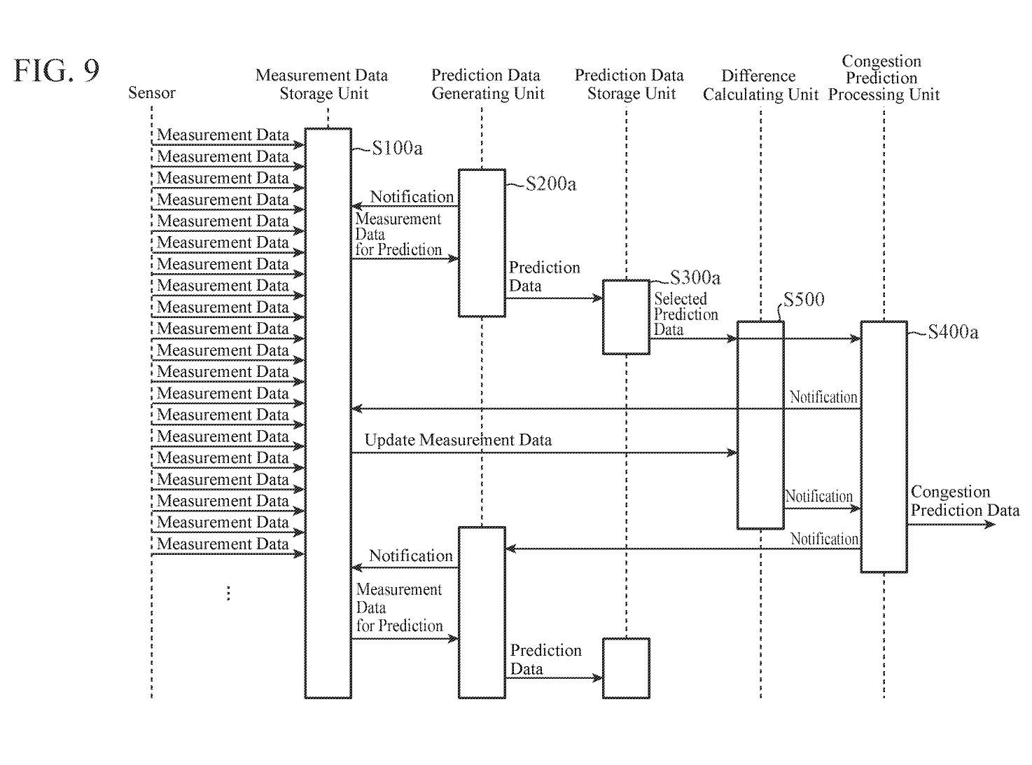

Next, the operation of the congestion prediction device according to Embodiment 2 will be explained using FIGS. 9 to 14.

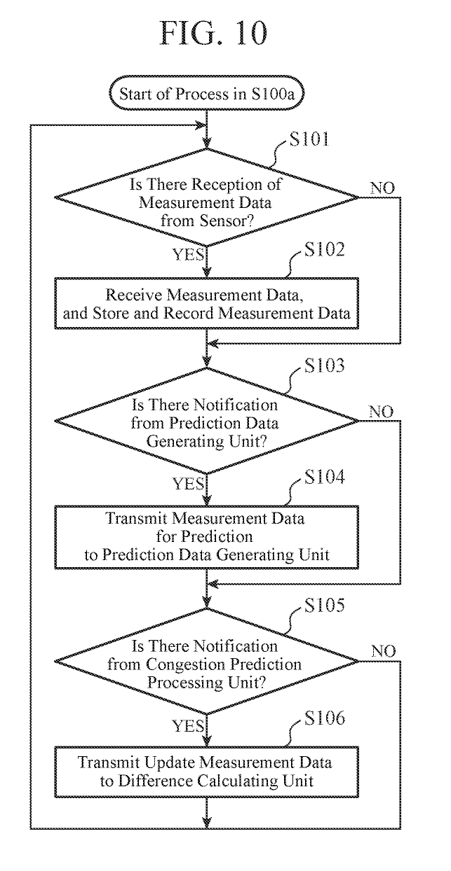

FIG. 9 is a sequence diagram showing processing performed by the congestion prediction device according to Embodiment 2. FIG. 10 is a flow chart showing processing performed by a measurement data storage unit 10 of the congestion prediction device according to Embodiment 2. Processes in steps S101 to S106 of this FIG. 10 are performed in step S100a of FIG. 9.

In steps S101 to S104 of FIG. 10, the measurement data storage unit 10 performs the same processes as those in steps S101 to S104 of FIG. 4.

In step S105, the measurement data storage unit 10 checks whether or not there is a notification from each of the plural congestion prediction processing units 40. When there is a notification from at least one of the plural congestion prediction processing units 40 (“YES” in step S105), the measurement data storage unit 10 advances to step S106, whereas when there is no notification (“NO” in step S105), the measurement data storage unit returns to step S101.

In step S106, the measurement data storage unit 10 transmits new measurement data which the measurement data storage unit receives from the sensor 1 at and after the time of transmitting measurement data for prediction to the prediction data generating unit 20, as update measurement data, to the difference calculating unit 50.

After step S106, the measurement data storage unit 10 returns to step S101.

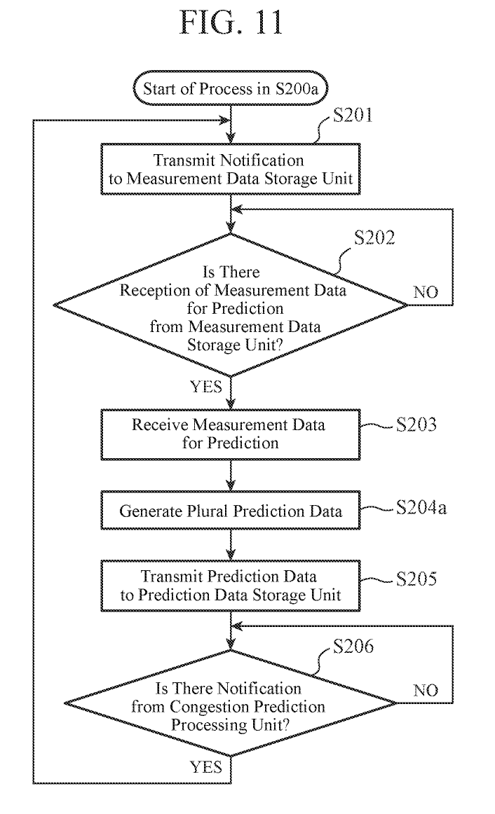

FIG. 11 is a flow chart showing processing performed by the prediction data generating unit 20 of the congestion prediction device according to Embodiment 2. Processes in steps S201 to S206 of this FIG. 11 are performed in step S200a of FIG. 9.

In steps S201 to S203 of FIG. 11, the prediction data generating unit 20 performs the same processes as those insteps S201 to S203 of FIG. 5.

In step S204a, the prediction data generating unit 20 predicts the number of persons who will pass through a measurement point during a future time period corresponding to a prediction data generation range, by using a linear approximation or the like, thereby generating plural prediction data. At that time, the prediction data generating unit 20 can generate plural prediction data by changing the approximation used thereby, or can generate plural prediction data by changing a range of use of the measurement data for prediction. When generating two prediction data by changing the range of use of the measurement data for prediction, for example, the prediction data generating unit 20 generates one prediction data on the basis of the latest five measurement data, and generates the other prediction data on the basis of the latest ten measurement data.

In steps S205 and S206, the prediction data generating unit 20 performs the same processes as those in steps S205 and S206 of FIG. 5.

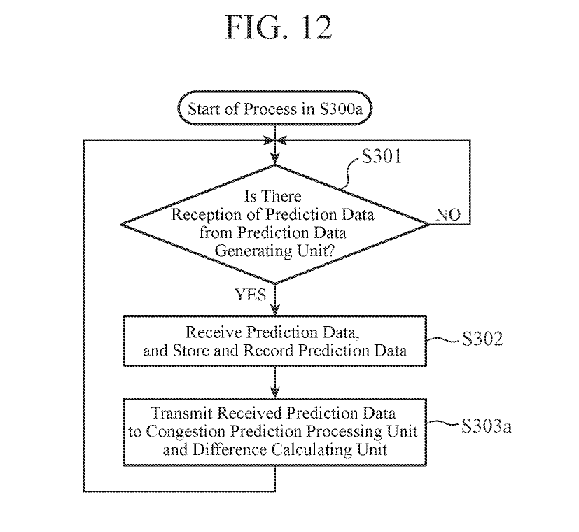

FIG. 12 is a flow chart showing processing performed by a prediction data storage unit 30 of the congestion prediction device according to Embodiment 2. Processes in steps S301 to S303a of this FIG. 12 are performed in step S300a of FIG. 9.

In steps S301 and S302 of FIG. 12, the prediction data storage unit 30 performs the same processes as those in steps S301 and S302 of FIG. 6.

In step S303a, the prediction data storage unit 30 allocates the plural prediction data stored in step S302 to the respective plural congestion prediction processing units 40 in a one-to-one correspondence manner, and transmits each of the plural prediction data to the corresponding congestion prediction processing unit 40 which is the corresponding allocation destination. Each of the plural prediction data which is transmitted to the corresponding congestion prediction processing unit 40 which is the corresponding allocation destination is referred to as selected prediction data. In this way, the prediction data storage unit 30 transmits plural selected prediction data to the respective plural congestion prediction processing units 40 individually. The prediction data storage unit 30 also transmits the plural selected prediction data which are transmitted to the respective plural congestion prediction processing units 40 to the difference calculating unit 50.

After step S303a, the prediction data storage unit 30 returns to step S301.

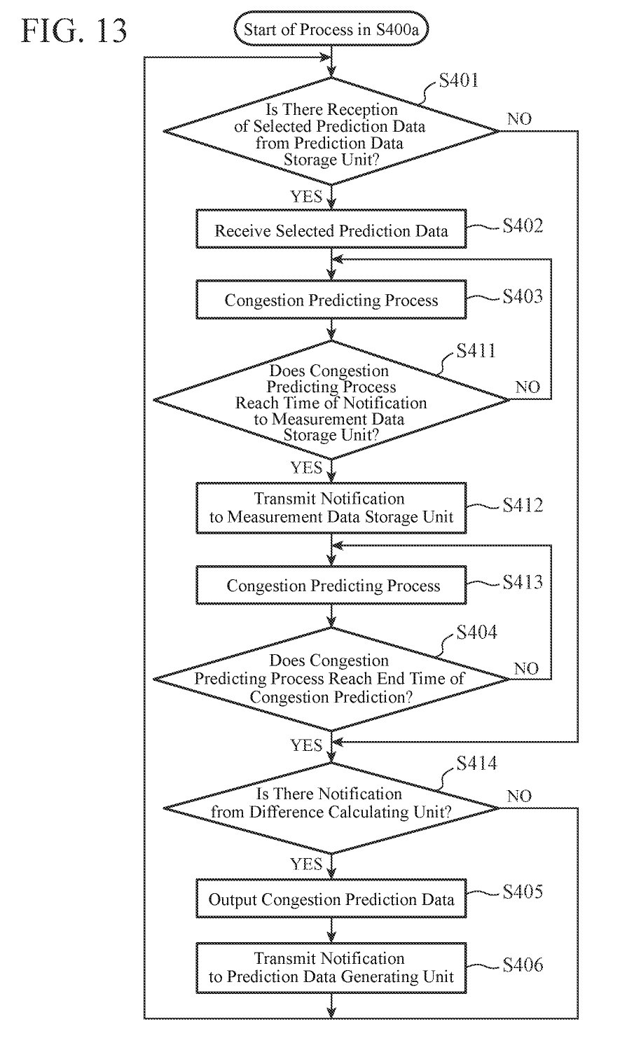

FIG. 13 is a flow chart showing processing performed by each of the plural congestion prediction processing unit 40 of the congestion prediction device according to Embodiment 2. Each of the plural congestion prediction processing units 40 performs the processing shown in the flow chart of FIG. 13. Processes in steps S401 to S414 of this FIG. 13 are performed in step S400a of FIG. 9.

In steps S401 to S403 of FIG. 13, each congestion prediction processing unit 40 performs the same processes as those in steps S401 to S403 of FIG. 7.

In step S411, each congestion prediction processing unit 40 checks whether the congestion predicting process has reached a time of notification to the measurement data storage unit. The time of notification to the measurement data storage unit is a parameter for determining when in the future after a start time of congestion prediction a notification is to be transmitted to the measurement data storage unit 10 while the congestion prediction is performed, and the parameter is set up with respect to an end time of congestion prediction as a reference. For example, the time which precedes the end time of congestion prediction by 100 steps is defined as the time of notification to the measurement data storage unit. The time of notification to the measurement data storage unit can be set to each congestion prediction processing unit 40 in advance, or can be set from outside the congestion prediction device as needed. When the congestion predicting process has reached the time of notification to the measurement data storage unit (“YES” in step S411), each congestion prediction processing unit 40 advances to step S412, whereas when the congestion predicting process has not reached (“NO” in step S411), each congestion prediction processing unit returns to step S403 and continues the congestion predicting process.

In step S412, each congestion prediction processing unit 40 transmits a notification to the measurement data storage unit 10. This notification causes the measurement data storage unit to transmit update measurement data to the difference calculating unit 50.

In step S413 and step S404 following this step S413, each congestion prediction processing unit 40 performs the same processes as those in steps S403 and S404 of FIG. 7. When the congestion predicting process has reached the end time of congestion prediction (“YES” in step S404), each congestion prediction processing unit 40 advances to step S414, whereas when the congestion predicting process has not reached (“NO” in step S404), each congestion prediction processing unit returns to step S413 and continues the congestion predicting process.

In step S414, each congestion prediction processing unit 40 checks whether or not there is a notification from the difference calculating unit 50. When there is a notification from the difference calculating unit 50 (“YES” in step S414), each congestion prediction processing unit 40 advances to step S405, whereas when there is no notification (“NO” in step S414), the congestion prediction processing unit returns to step S401.

In steps S405 and S406 following step S414, each congestion prediction processing unit 40 performs the same processes as those in steps S405 and S406 of FIG. 7.

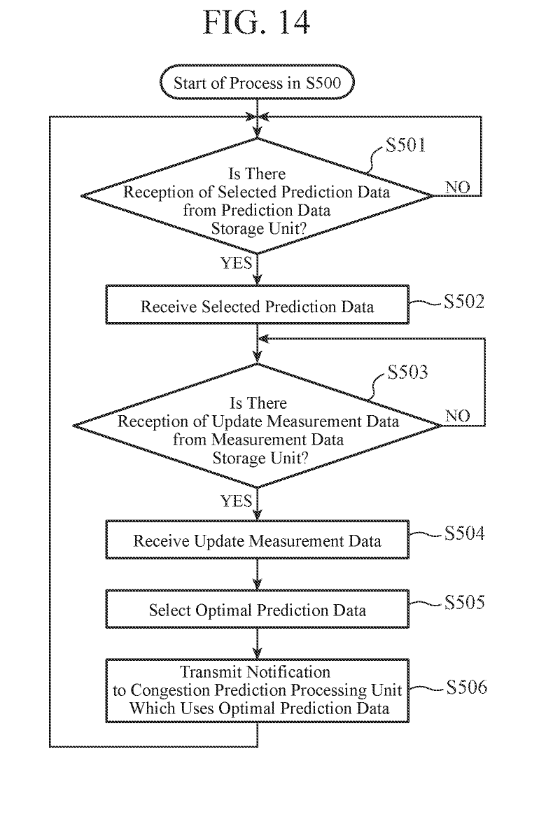

FIG. 14 is a flow chart showing processing performed by the difference calculating unit 50 of the congestion prediction device according to Embodiment 2. Processes in steps S501 to S506 of this FIG. 14 are performed in step S500 of FIG. 9.

In step S501 of FIG. 14, the difference calculating unit 50 checks whether or not there is reception of plural selected prediction data from the prediction data storage unit 30. When there is reception of plural selected prediction data (“YES” in step S501), the difference calculating unit 50 advances to step S502, whereas when there is no reception (“NO” in step S501), the difference calculating unit repeats this step S501.

In step S502, the difference calculating unit 50 receives the plural selected prediction data from the prediction data storage unit 30.

In step S503, the difference calculating unit 50 checks whether or not there is reception of update measurement data from the measurement data storage unit 10. When there is reception of update measurement data (“YES” in step S503), the difference calculating unit 50 advances to step S504, whereas when there is no reception (“NO” in step S503), the difference calculating unit repeats this step S503.

In step S504, the difference calculating unit 50 receives the update measurement data from the measurement data storage unit 10.

In step S505, the difference calculating unit 50 compares each of the plural selected prediction data received from the prediction data storage unit 30 with the update measurement data received from the measurement data storage unit 10, by using a method such as a method of calculating the sum of absolute differences, and selects selected prediction data having the smallest difference between the selected prediction data and the update measurement data, as optimal prediction data.

In step S506, the difference calculating unit 50 selects, from among the plural congestion prediction processing units 40, at least one congestion prediction processing unit 40 which performs the congestion predicting process by using the optimal prediction data selected in step S505, and transmits a notification to the at least one congestion prediction processing unit 40. This notification causes the at least one congestion prediction processing unit 40 to output, from among the plural congestion prediction data, the optimal congestion prediction data to the outside.

After step S506, the difference calculating unit 50 returns to step S501.

Although in the above-mentioned explanation, the plural congestion prediction processing units 40 are configured so as to perform the respective plural congestion predicting processes in parallel, the single congestion prediction processing unit 40 can be configured to perform the plural congestion predicting processes in turn.

As mentioned above, the congestion prediction device according to Embodiment 2 is configured so as to include the difference calculating unit 50 that selects, from among plural prediction data generated by the prediction data generating unit 20, prediction data having the smallest difference between the prediction data and measurement data which the sensor 1 newly outputs during the process of predicting the congestion state. Further, the at least one congestion prediction processing unit 40 is configured to generate plural congestion prediction data by using the plural prediction data generated by the prediction data generating unit 20, and output, among the plural congestion prediction data, congestion prediction data which is generated using the prediction data selected by the difference calculating unit 50. As a result, optimal congestion prediction data having a high degree of prediction accuracy can be outputted.

It is to be understood that any combination of two or more of the above-mentioned embodiments can be made, various changes can be made in any component according to any one of the above-mentioned embodiments, and any component according to any one of the above-mentioned embodiments can be omitted within the scope of the invention.

Further, although the congestion prediction device previously explained is configured so as to perform the congestion prediction for one measurement point by using the single sensor 1, the congestion prediction device can be alternatively configured so as to perform the congestion prediction for plural measurement points by using respective plural sensors 1.

### INDUSTRIAL APPLICABILITY

Because the congestion prediction device according to the present invention does not have to prepare data in advance, the congestion prediction device is suitable particularly for prediction of a congestion state in a first-time event or at a place where an event is held for the first time.

### REFERENCE SIGNS LIST

1 sensor, 10 measurement data storage unit, 20 prediction data generating unit, 30 prediction data storage unit, 40 congestion prediction processing unit, 50 difference calculating unit, 101 processor, 102 memory, 103 input interface, and 104 output interface.

1.-4. (canceled)

5. A congestion prediction device comprising:
a prediction data generator to predict the number of persons who will pass through a measurement point in a future time, by using measurement data outputted by a sensor to measure the number of persons who have passed through the measurement point, thereby generating prediction data; and
at least one congestion prediction processor to predict a congestion state of the measurement point in a future time by using the prediction data generated by the prediction data generator, thereby generating and outputting congestion prediction data,
wherein the at least one congestion prediction processor reflects measurement data which the sensor newly outputs during a process of predicting the congestion state, in the congestion prediction data during the process of predicting, thereby outputting the congestion prediction data.

6. The congestion prediction device according to claim 5,
further comprising a difference calculator to select, from among plural prediction data generated by the prediction data generator, prediction data having a smallest difference between the prediction data and the measurement data which the sensor newly outputs during the process of predicting the congestion state,
wherein the at least one congestion prediction processor generates plural congestion prediction data by using the respective plural prediction data generated by the prediction data generator, and outputs, among the plural congestion prediction data, congestion prediction data which is generated using the prediction data selected by the difference calculator.

7. A congestion prediction method comprising:
predicting the number of persons who will pass through a measurement point in a future time, by using measurement data outputted by a sensor for measuring the number of persons who have passed through the measurement point, thereby generating prediction data; and
predicting a congestion state of the measurement point in a future time by using the generated prediction data, thereby generating and outputting congestion prediction data,
wherein measurement data which the sensor newly outputs during a process of predicting the congestion state is reflected in the congestion prediction data during the process of predicting, and the congestion prediction data is outputted thereby.

8. A congestion prediction device comprising:
a processor to execute a program; and
a memory to store the program which, when executed by the processor, performs processes of,
predicting the number of persons who will pass through a measurement point in a future time, by using measurement data outputted by a sensor to measure the number of persons who have passed through the measurement point, thereby generating prediction data, and
predicting a congestion state of the measurement point in a future time by using the generated prediction data, thereby generating and outputting congestion prediction data,
wherein measurement data which the sensor newly outputs during a process of predicting the congestion state is reflected in the congestion prediction data during the process of predicting, and the congestion prediction data is outputted thereby.

9. The congestion prediction device according to claim 8,
wherein the processes includes selecting, from among generated plural prediction data, prediction data having a smallest difference between the prediction data and the measurement data which the sensor newly outputs during the process of predicting the congestion state, and
generating plural congestion prediction data by using the respective generated plural prediction data, and outputting, among the plural congestion prediction data, congestion prediction data which is generated using the selected prediction data.
